(19) United States
(12) Patent Application Publication
(10) Pub. No.: US 2011/0205398 A1
(43) Pub. Date: Aug. 25, 2011

(54) IMAGING PROCESSING SYSTEM AND DIGITAL CAMERA

(75) Inventor: Toshinobu HATANO, Kyoto (JP)

(73) Assignee: PANASONIC CORPORATION, Osaka (JP)

(21) Appl. No.: 13/097,960

(22) Filed: Apr. 29, 2011

Related U.S. Application Data
(63) Continuation of application No. PCT/JP2008/003429, filed on Nov. 21, 2008.

(51) Int. Cl. H04N 5/335; H04N 5/76

(52) U.S. Cl. 348/231.99; 348/294; 348/300; 348/E05.091

(57) ABSTRACT

To prevent the S/N performance of signals handled by an analog front-end from deteriorating, an imaging processing system according to the present invention has an analog front-end device configured to output a first digital data in a blanking period of a solid imaging sensor, and a digital signal processing device configured to enable an internal operation of the processing device during the blanking period and render the internal operation standby during any period but the blanking period.

### FIELD OF THE INVENTION

The present invention relates to an imaging processing system configured to convert a video signal (analog electric charge signal) outputted from a solid image sensor, such as an image sensor developed for digital camera, into digital data adapted to the analog electric charge signal and output the digital data to thereafter perform digital image signal processes thereto.

### BACKGROUND OF THE INVENTION

In recent years, the camera industry has been experiencing the rapidly ongoing technology transition from analog to digital devices. The market of digital still cameras which require no film development, in particular, is roaring and attracting consumers. Most of mobile telephones selling now are camera-equipped telephones, and pixels and image processes increasingly upgraded in digital still cameras are contributing to remarkable improvements of an image quality.

A sensor peripheral unit of the digital camera is conventionally loaded with an analog front-end device. The analog front-end device converts an image signal (analog electric charge signal) outputted from a solid image sensor into digital data adapted to the analog electric charge signal and outputs the digital data. A solid image sensor and a digital signal processor (DSP), as well as the analog front-end device, are configured of semiconductor integrated circuits, and the semiconductor integrated circuits mounted on a printed wiring board constitute an imaging processing system.

FIG. 5 is a block diagram illustrating structural elements of a digital camera equipped with a conventional imaging processing system. Referring to the drawing,

A is a sensor peripheral unit, B is a digital signal processing device in charge of image processes, 1 is an MOS image sensor which is a solid image sensor, 2 is an analog front-end device, 21 is a synchronous signal generator section which periodically generates a synchronous signal (SSG), 22 is a timing generator section which generates pulses for driving the image sensor 1 (TG), 23 is a CDS (correlated double sampling) section, 24 is a GCA (gain control amplifier) section, 25 is an AD converter section, 28 is a clock multiplier section which multiplies a clock inputted from outside and outputs the multiplied clock, 29a is a parallel/serial data output section, and 30 is a CPU interface. In the digital camera, the analog front-end device 2 and the digital signal processing device B constitute an imaging processing system.

A digital data outputted from the analog front-end device 2 is subjected to image processes such as luminance signal process, color separation process, and color matrix process performed by the digital signal processing device B.

A consideration is given to what causes noise which appears on a display screen of the imaging processing system. A power supply noise is generated when the analog front-end device 2 in charge of AD conversion outputs the digital data. The power supply noise penetrates into the image sensor 1 through power supply lines (Vcc line and ground line) on the printed wiring board. Then, the following events occur:
the power supply noise penetrates into the analog electric charge signal supplied from the image sensor 1 to the analog front-end device 2; and
the power supply noise penetrates into the input terminal side from the output circuit side through the power supply lines and semiconductor substrate in the analog front-end device 2.

These events are the main causes of noise which appears on the display screen (image disturbance).

An LSI output circuit is required to drive a larger load than any non-LSI circuits in a chip, for example, printed wiring. Therefore, the LSI output circuit is conventionally equipped with output elements larger than any elements constituting the other internal circuits such as AD converter (at least 10 times as large) and designed so that a relatively large amount of current can flow therein. A disadvantage of such an output circuit is that a large through current flow and a large load-driven current flow are generated when output signals are switched over, resulting in noise superimposed on power supply. The noise thus generated is transmitted to input-side circuits, more specifically, the noise is transmitted to an input circuit, and then further transmitted to any other internal circuits through a substrate. The noise transmitted to the input-side circuits is amplified alongside the analog electric charge signal by an amplifier circuit provided in the analog front-end device 2 to amplify an analog signal such as PGA (programmable gain amplifier). As a result, a displayed image has a poor image quality.

To reduce the noise, it is necessary to lessen variation of signals and number of signals transmitted to and from the analog front-end device 2 and the digital signal processing device B in the sensor peripheral unit A, which contributes to reduction of power consumption as well. A conventional imaging processing system which successfully lessened the variation of signals and number of signals in a sensor peripheral unit has a plurality of n-bit AD conversion devices and a plurality of PS (parallel/serial) conversion devices in the sensor peripheral unit (for example, see the Patent Document 1). The n-bit AD conversion devices are provided depending on number of channel outputs of the image sensor to convert the respective channel outputs into digital signals. The PS conversion devices convert the outputs of the n-bit AD conversion devices into serial data depending on the output of a PLL circuit.

FIG. 6 is a timing chart illustrating an operation of the conventional imaging processing system. HBLK illustrated in the drawing is a horizontal synchronous signal. In a horizontal blanking period during which the horizontal synchronous signal HBLK stays at “H” level, there is no image signal output. In a valid signal output period during which the horizontal synchronous signal HBLK stays at “L” level, valid analog electric charge signals for a line are outputted. In the valid signal output period, the image sensor 1 is driven to generate the analog electric charge signals, and the generated analog electric charge signals are gain-controlled by the GCA section 24, and the gain-controlled analog electric charge signals are converted into digital data by the AD converter section 25. Then, the digital data is parallel/serial-converted by the parallel/serial data output section 29a, and the parallel/serial-converted digital data is outputted to the digital signal processing device B. During the data process described so far, the signal processes by the analog front-end device 2 (GCA24 and AD conversion device 25) and the digital data output from the analog front-end device 2 to the digital signal processing device B are concurrently carried out.
Patent Document 1: Unexamined Japanese Patent Applications Laid-Open No. 2005-244709

### DISCLOSURE OF THE INVENTION

### Problem to be Solved by the Invention

The conventional imaging processing system, however, fails to eliminate adverse impacts on the analog front-end device 2 caused by an operation noise generated in the digital signal processing device B operating concurrently with the analog front-end device 2 as illustrated in FIG. 6. In other words, the operation of the digital signal processing device B requires a larger energy than the operation of the sensor peripheral unit A (more specifically, image sensor 1; generating drive pulses and outputting signals, and analog front-end device 2; transmitting analog electric charge signals). Therefore, an operation noise of an output buffer in the digital signal processing device B, memory access clocks (having a clock frequency multiplied to be higher than pixel clocks of the image sensor 1), and folding components of a high-frequency noise when the serial data is outputted adversely impact on the sensor peripheral unit A through the power supply or GND or radiation. This not only incurs deterioration of a signal S/N ratio but also generates a folding noise or fixed pattern noise. The conventional imaging processing system, however, is unable to avoid these adverse impacts.

The present invention was accomplished to solve these conventional technical problems, and a main object thereof is to avoid deterioration of the S/N ratio of signals handled by the analog front-end device when the system operation noise is generated by the data output from the sensor peripheral unit to the digital signal processor and processing of tasks in the digital signal processor.

### Means for Solving the Problem

1) An imaging processing system according to the present invention comprises:

an analog front-end device configured to convert an analog electric charge signal outputted from a solid image sensor into a first digital data; and

a digital signal processing device configured to perform image processes to the first digital data, wherein

the analog front-end device outputs the first digital data in a blanking period of the solid image sensor, and

the digital signal processing device enables an internal operation of the digital signal processing device during the blanking period but renders the internal operation standby during any period but the blanking period.

According to the imaging processing system thus configured, a time period when the first digital data generated through AD conversion in the analog front-end device is outputted from the analog front-end device to the digital signal processing device is confined solely to the blanking period of the solid image sensor (mostly in a horizontal blanking period). The blanking period does not include a valid signal output period which is an output timing of the analog electric charge signal outputted from the solid image sensor. Therefore, any noise caused by outputting the first digital data from the analog front-end device to the digital signal processing device is generated exclusively in the blanking period. The digital signal processing device processes tasks in the blanking period alone, therefore, any noise resulting from the processing of tasks in the digital signal processing device is generated exclusively in the blanking period as well. This prevents the concurrence of the output of the first digital data by the analog front-end device with the processing of tasks by the digital signal processing device. As a result, the S/N performance of signals handled by an image sensor or an AD converter section of the analog front-end device can be prevented from deteriorating in the event of a system operation noise resulting from the operation or data output by the digital signal processing device.

2) In the imaging processing system configured as described in 1), the analog front-end device preferably comprises:

a correlated double sampling section configured to convert the analog electric charge signal into a continuous analog signal by removing a noise therefrom;

an amplifier section configured to control a gain of an output signal of the correlated double sampling section and further control a direct current component of the output signal based on feedback control;

an n-bit AD converter section configured to generate the first digital data by analog-digital converting an output signal of the amplifier section;

a memory used as a temporary storage of the first digital data outputted from the AD converter section;

a first memory control section configured to write the first digital data in the memory based on a write clock signal and reads the first digital data from the memory based on a read clock signal having a clock frequency higher than a clock frequency of the write clock signal;

a digital data output section configured to output the first digital data read from the memory to the digital signal processing device;

a synchronous signal generator section configured to generate a synchronous signal based on which a cycle of reading the analog electric charge signal is set in the solid image sensor;

a timing generator section configured to generate a pulse for driving the solid image sensor based on the synchronous signal; and

a clock multiplier section configured to generate the write clock signal based on a clock inputted from outside and generate the read clock signal by multiplying the clock by n times, and then supply the generated write clock signal and read clock signal to the first memory control section.

In the imaging processing system according to the present invention, the analog front-end device further comprises the memory, first memory control section, and clock multiplier section. More specifically, the memory is inserted between an AD converter section and a digital data output section, and the memory is controlled by the first memory control section based on the read cock signal supplied from the clock multiplier section, so that an operational effect of the configuration in 1) is accomplished.

3) In the imaging processing system configured as described in 2), it is preferable that the memory have a memory capacity large enough to buffer the first digital data for at least a line of the solid image sensor, and the first memory control section write the first digital data in the memory in an output period of the analog electric charge signals for at least a line and reads the first digital data from the memory in a horizontal blanking period which immediately follows the output period.

Because the output period of the first digital data is confined solely to the horizontal blanking period, an output time is shorter than any imaging processing system wherein the first digital data is outputted in the valid signal output period. To compensate for the shorter output time, the first digital data is read faster from the memory.

4) In the imaging processing system configured as described in 2), the digital signal processing device preferably comprises:

a pre-processing section configured to perform DC and gain adjustments to the first digital data received from the analog front-end device to generate a second digital data;

a sharable memory used as a storage of the second digital data outputted from the pre-processing section;

a second memory control section configured to write the second digital data in the sharable memory and read the second digital data from the sharable memory;

a group of signal processing sections configured to perform various image processes to the second digital data read from the sharable memory;

an external I/F processing section serving as an interface with outside;

a CPU configured to control the operations of the group of signal processing sections; and

a clock control section configured to multiply or divide the clock inputted from outside by n times and supply the multiplied or divided clock to the group of processing sections.

The imaging processing system according to the present invention further comprises the clock control section configured to multiply or divide the clock inputted from outside by n times and supply the multiplied or divided clock to the group of processors. When the group of signal processing sections is controlled by using the clock frequency-controlled by the clock control section, an operational effect of 1) is accomplished.

5) The group of signal processing sections preferably includes:

a image signal processing section configured to perform a brightness signal process and a color signal process to the second digital data read from the sharable memory;

a resizing section configured to perform a resizing process to the signal-processed second digital data outputted from the image signal processing section;

a compression/decompression section configured to compress or decompress the resized second digital data outputted from the resizing section;

a region detection section configured to perform a region detection process to the resized second digital data outputted from the resizing section; and

a display processing section configured to output the resized second digital data outputted from the resizing section outside as a display data.

6) In the imaging processing system configured as described in 4), the digital signal processing device preferably enables the operation of the pre-processing section during a horizontal blanking period but renders the operation standby during any period but the horizontal blanking period, the digital signal processing device further enabling the operations of the group of signal processing sections during the horizontal blanking period and a vertical blanking period.

The operations of these structural elements are not enabled during any period but the horizontal blanking period (including the valid signal output period of the solid image sensor). Therefore, a minimum range of operation setting including standby but not including any access to the sharable memory can be arranged during the horizontal blanking period.

7) In the imaging processing system configured as described in 4), the digital signal processing device preferably enables the operation of the CPU alone but renders the group of processing sections standby when a minimum range of operation setting including standby is arranged in the output period of the analog electric charge signals of the solid image sensor, the digital signal processing device further rendering the CPU standby in the output period of the analog electric charge signals of the solid image sensor.

The only structural element of the digital signal processing device operational during the output period of the analog electric charge signals of the solid image sensor is the CPU, practically reducing any noise to minimum.

8) In the imaging processing system configured as described in 1), the analog front-end device preferably performs parallel output of the first digital data but fixes an output electric level of the first digital data during any period but a horizontal blanking period of the solid image sensor.

This technical characteristic eradicates power supply and GND noise components due to the output buffer operation of the digital signal processing device, thereby reducing the noise possibly affecting sensor signal outputs and drive pulses.

9) In the imaging processing system configured as described in 2), the analog front-end device preferably generates the first digital data as a parallel data and converts the first digital data into a serial data through low-voltage differential conversion, and then transmits the serial data to the digital signal processing device, the analog front-end device further rendering the digital data output section standby to set an output level of the analog front-end device to fixed logic during any period but a horizontal blanking period.

This technical characteristic eradicates any high-frequency power supply and GND noise components resulting from the LVDS operation (which is to generate the first digital data as a parallel data and convert the first digital data into a serial data through low-voltage differential conversion, and then transmit the serial data to the digital signal processing device), and largely reduces power consumption necessary for the LVDS operation.

10) In the imaging processing system configured as described in 9), the digital signal processing device preferably renders the pre-processing section standby to set an output level of the digital signal processing device to fixed logic during any period but the horizontal blanking period.

This technical characteristic eradicates any high-frequency power supply and GND noise components resulting from the LVDS operation, and largely reduces power consumption necessary for the LVDS operation.

11) In the imaging processing system configured as described in 2), the analog front-end device preferably generates the first digital data as a parallel data and converts the first digital data into a serial data through low-voltage differential conversion, and then optically transmits the serial data by using an optical device to the digital signal processing device through optical fiber by way of an optical transceiver, the analog front-end device further rendering the optical transceiver and the digital data output section standby to set an output optical level of the analog front-end device to one of a bright level and a dark level during any period but a horizontal blanking period.

This technical characteristic largely reduces power consumption in fast optical data transmission using an optical transceiver.

12) In the imaging processing system configured as described in 11), the digital signal processing device preferably receives the first digital data transmitted through the optical fiber using the optical receiver, and renders the optical transceiver standby to set an output electric level of the first digital data to fixed logic during any period but the horizontal blanking period.

This technical characteristic largely reduces power consumption in fast optical data reception using an optical receiver.

13) The imaging processing system configured as described in 11) preferably further includes a power supply device configured to supply power to the analog front-end device and the digital signal processing device, wherein

the power supply device supplies power independently to the analog front-end device and the digital signal processing device without direct connection between a reference GND of the analog front-end device and a reference GND of the digital signal processing device.

Because the analog front-end device and the digital signal processing device can be independently supplied with power, a noise generated in one of the analog front-end device and the digital signal processing device is prevented from impacting the other. Therefore, a system operation noise resulting from the operation or data output of the digital signal processing device, if generated, does not deteriorate the S/N performance of signals handled by the image sensor and AD converter section of the analog front-end device.

14) In the imaging processing system configured as described in 9), it is preferable that the first memory control section read the first digital data from the memory based on the read clock signal obtained by multiplying the write clock signal by a multiplying factor equal to or larger than a third integer, the third integer being obtained by multiplying a first integer which is a ratio of lengths (decimal places are carried) of the horizontal blanking period and the valid signal output period (length of valid signal output period/length of horizontal blanking period) by a second integer indicating a data bus width after A/D conversion, and

the digital data output section transfer the first digital data in the horizontal blanking period based on a transfer clock signal having a transfer clock frequency equal to a read clock frequency of the read clock signal.

The data output from the digital data output section of the analog front-end device to the digital signal processing device can be completed during the horizontal blanking period.

15) In the imaging processing system configured as described in 2), it is preferable that the first digital data be a parallel data, and a transfer rate of the digital data output section be set so that the output of the first digital data is completed during the horizontal blanking period.

16) In the imaging processing system configured as described in 15), the digital data output section preferably transfers the first digital data based on a first transfer clock signal having a first transfer clock frequency in the valid signal output period, and transfers the first digital data in the horizontal blanking period based on a second transfer clock signal having a second transfer clock frequency obtained by multiplying the first transfer clock frequency by a multiplying factor equal to or larger than an integer which is a ratio of lengths (decimal places are carried) of the horizontal blanking period and the valid signal output period (length of valid signal output period/length of horizontal blanking period).

The data output from the digital data output section of the analog front-end device to the digital signal processing device can be completed during the horizontal blanking period.

17) A digital camera according to the present invention is equipped with the imaging processing system configured as described in 1) and the solid image sensor.

### Effect of the Invention

The present invention is technically characterized in that the digital data output by the analog front-end device and the processes of tasks by the digital signal processing device are not concurrent with each other. This technical advantage can prevent the S/N performance of signals handled by the solid image sensor and the AD converter section from deteriorating when a system operation noise occurs due to the data output from the analog front-end device to the digital signal processing device or the processing of tasks by the digital signal processing device.

### BRIEF DESCRIPTION OF THE DRAWINGS

FIG. 1 is a block diagram illustrating a configuration of an imaging processing system (illustrating details of a digital signal processing device) according to an exemplary embodiment of the present invention.

FIG. 2 is a block diagram illustrating the configuration of the imaging processing system (illustrating details of an analog front-end device) according to the exemplary embodiment.

FIG. 3 is a timing chart illustrating an operation of the imaging processing system according to the exemplary embodiment.

FIG. 4 is a block diagram illustrating a configuration of an imaging processing system (illustrating details of an analog front-end device) according to another exemplary embodiment of the present invention.

FIG. 5 is a block diagram illustrating a configuration of a conventional imaging processing system.

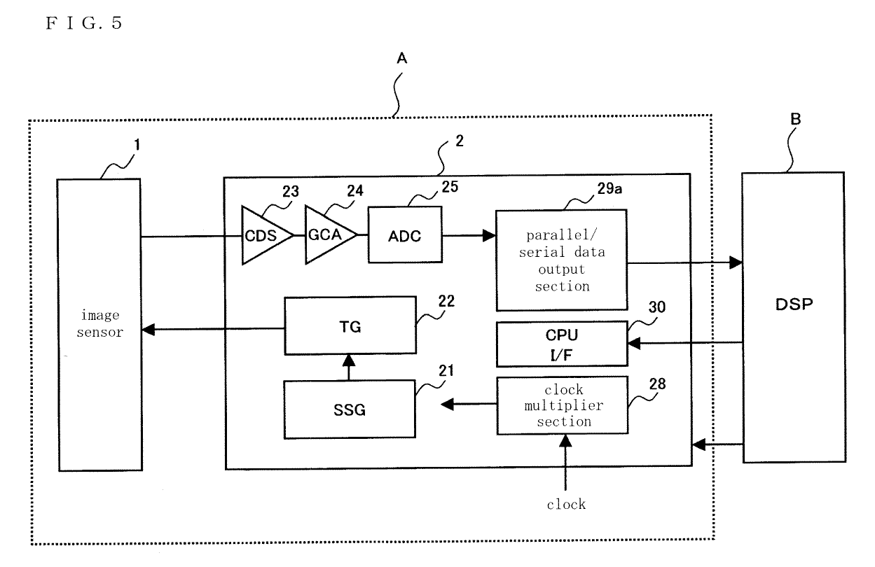

FIG. 6 is a timing chart illustrating an operation of the conventional imaging processing system.

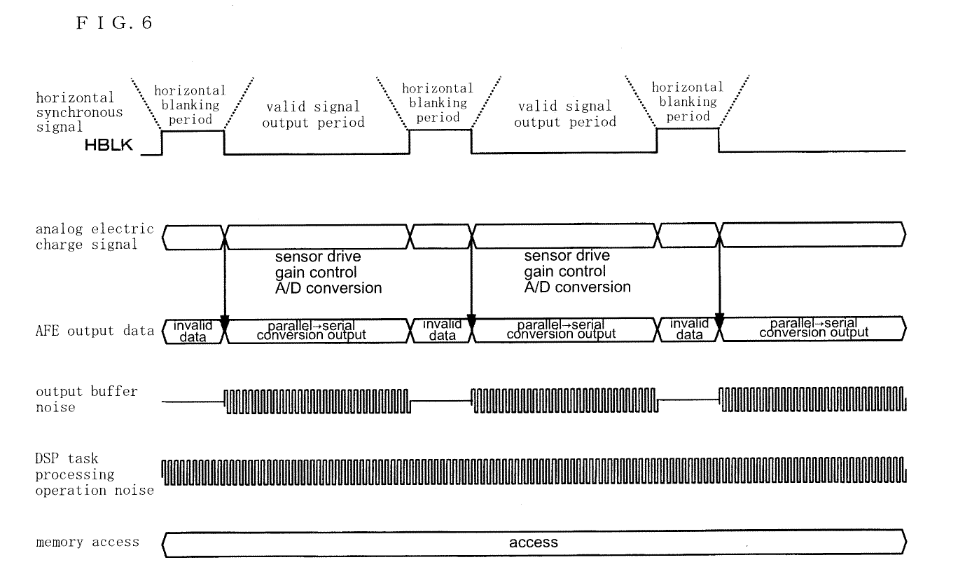

### DESCRIPTION OF REFERENCE SYMBOLS

A sensor peripheral unit
B digital signal processing device
1 image sensor
2 analog front-end device
21 synchronous signal generator section
22 timing generator
23 CDS (correlated double sampling) section
24 GCA (gain control amplifier section)
25 AD converter section
26 RAM (memory used as a temporary storage of data outputted from AD converter section)
27 memory control section
28 clock multiplier section
29 digital data output section
30 CPU interface
31 pre-processing section
32 sharable memory
33 memory control section
34 image signal processing section
35 resizing section
36 compression/decompression section
37 region detection section
38 display processing section
39 external I/F processing section
40 flash memory
41 CPU for system control
42 clock control section (multiplying/dividing)

### EXEMPLARY EMBODIMENTS FOR CARRYING OUT THE INVENTION

Hereinafter, exemplary embodiments of an imaging processing system according to the present invention are described in detail referring to the drawings.

### Exemplary Embodiment 1

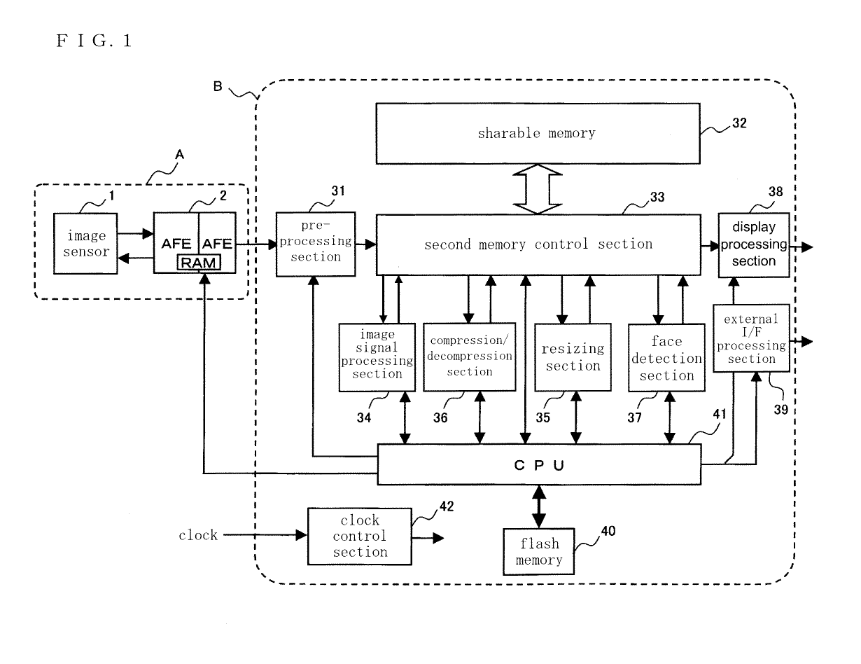

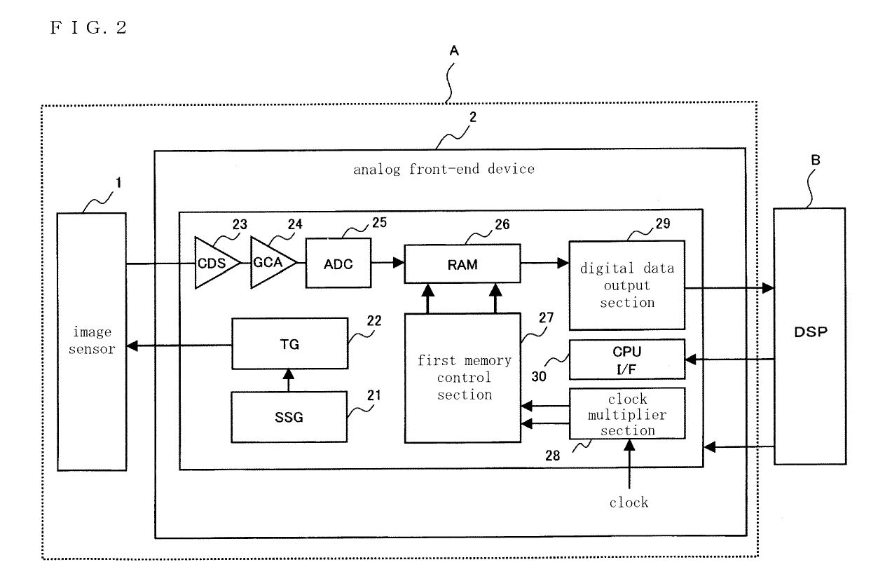

FIG. 1 is a block diagram illustrating a configuration of a digital camera comprising an imaging processing system (illustrating details of a digital signal processing device) according to an exemplary embodiment of the present invention. FIG. 2 is a block diagram illustrating the configuration of the imaging processing system (illustrating details of an analog front-end device) according to the exemplary embodiment. The digital camera has a sensor peripheral unit A and a digital signal processing device (DSP) B. The sensor peripheral unit A includes an image sensor (solid image sensor) 1 and an analog front-end device 2. In the digital camera, the structural elements other than the image sensor 1 (analog front-end device 2 and digital signal processing device B) constitutes the imaging processing system.

The analog front-end device 2 includes a synchronous signal generator section (SSG) 21 configured to periodically generate a synchronous signal, a timing generator (TG) section 22 configured to periodically generate pulses for driving the image sensor 1, a CDS (correlated double sampling) section 23 configured to remove a noise from an analog electric charge signal inputted from the image sensor 1, a GCA (gain control amplifier) section 24 configured to control a gain of a signal and further control a direct current component of the signal through feedback control, an n-bit AD conversion section 25 configured to AD-convert an output of the GCA section 24 to obtain an image signal data (RGB data) called herein a first digital data, a RAM (memory) 26 used as a temporary storage of an output data of the AD converter section 25, a first memory control section 27 configured to control write and read of the first digital data with respect to the RAM 26, a clock multiplier section 28 configured to generate a write clock signal based on a clock inputted from outside and generate a read clock signal by multiplying the input clock by n times, a digital data output section 29 configured to output the first digital data read from the RAM 26 to the digital signal processing device B in the form of parallel data or serial data in a horizontal blanking period, and a CPU interface 30 configured to access an internal register of the analog front-end device 2 from an external CPU or a CPU provided in the digital signal processing device B for initial setting or changing an operation mode.

The analog front-end device 2 including these structural elements converts an image signal (analog signal) outputted from the image sensor 1 into the first digital data (image signal data) and outputs the first digital data to the digital signal processing device B. The analog front-end device 2 according to the present exemplary embodiment has one output channel.

The image sensor 1 connected to the analog front-end device 2 converts an incident image light through a lens (not illustrated in the drawings) into an analog electric charge signal (image signal which is an analog dot sequential signal) using a photo diode. The image sensor 1 periodically outputs the analog electric charge signals for a line in synchronization with the given drive pulses (vertical drive pulse and horizontal drive pulse). More specifically, the image sensor 1 outputs the analog electric charge signals for a line in a period during which a horizontal synchronous signal HBLK is at “L” level. The period when the image sensor 1 outputs the analog electric charge signals for a line is called a valid signal output period. A period when the output of the analog electric charge signals is invalid is called a horizontal blanking period. In the description of the present exemplary embodiment, the period when the horizontal synchronous signal HBLK is at “L” level is the valid signal output period, and the period when the horizontal synchronous signal HBLK is at “H” level is the horizontal blanking period (invalid period).

The digital signal processing device B includes a DSP (digital signal processor). The digital signal processing device B includes a pre-processing section 31 configured to generate a second digital data by performing DC and gain adjustments to the first digital data outputted from the analog front-end device 2, a sharable memory 32 used as a storage of the second digital data outputted from the pre-processing section 31, a second memory control section 33 configured to control write and read of the second digital data with respect to the sharable memory 32, an image signal processing section 34 configured to read the second digital data recorded in the sharable memory 33 therefrom to perform a bright signal process and a color signal process thereto, a resizing section configured to arbitrarily resize the second digital data processed by the image signal processing section 34, a compression/decompression section configured to compress or decompress the resized second digital data, a region detection section 37 configured to detect a particular region such as face in the resized second digital data, a display processing section 38 configured to output the resized second digital data outside as a display data, and an external I/F processing section 39 serving as an interface for an external recording medium or personal computer. The digital signal processing device B is provided with the sharable memory 32 used as a temporary storage of the second digital data obtained by processing the first digital data supplied from the analog front-end device 2. The digital signal processing device B accesses the sharable memory 32 based on the control by the CPU 41 operated by an execution program read from a flash memory 40 to perform the various processes. The clock control section 42 multiplies or divides the clock inputted from outside by n times and supplies the resulting clock to the respective processing sections.

The operation of the sensor peripheral unit A is described. The CPU interface 30 accesses the internal register of the analog front-end device 2 by way of the external CPU or CPU provided in the digital signal processing device B for initial setting and change the operation mode. The synchronous signal generator section 21 generates the horizontal and vertical synchronous signals. The horizontal synchronous signal includes a horizontal blanking signal. The timing generator section 22 generates the pulses for driving the image sensor 1 (vertical and horizontal drive pulses) depending on the output of the synchronous signal generator section 21.

The CDS section 23 reduces any noise included in the output of the image sensor 1 (analog electric charge signal) by using the correlated double sampling technique. More specifically, the CDS section 23 having a sample hold circuit reduces a 1/f noise included in the analog electric charge signal using the sample hold circuit and converts the analog electric charge signal in which the 1/f noise is reduced into a continuous signal. The GCA section 24 gain-controls the continuous signal (analog electric charge signal) so as to have a given amplitude, and also controls a direct current component of the continuous signal through feedback control. The AD converter section 25 AD-converts the output of the GCA section 24 into the image signal data (RGB data) which is the first digital data. The RAM 26 temporarily stores therein the first digital data (RGB data). The first memory control section 27 controls the data write and read with respect to the RAM 26. More specifically, the first memory control section 27 writes the output of the AD converter section 25 in the RAM 26 in the period when the analog electric charge signals are outputted from the image sensor 1, and reads the first digital data for a line written in the RAM 26 therefrom in the horizontal blanking period. The first digital data is read in synchronization with the read clock signal obtained by multiplying the clock inputted from outside of the analog front-end device 2. The digital data output section 29 converts the first digital data read from the RAM 26 in the horizontal blanking period in the form of parallel data or serial data in synchronization with the read clock signal, and outputs the resulting data to the digital signal processing device B.

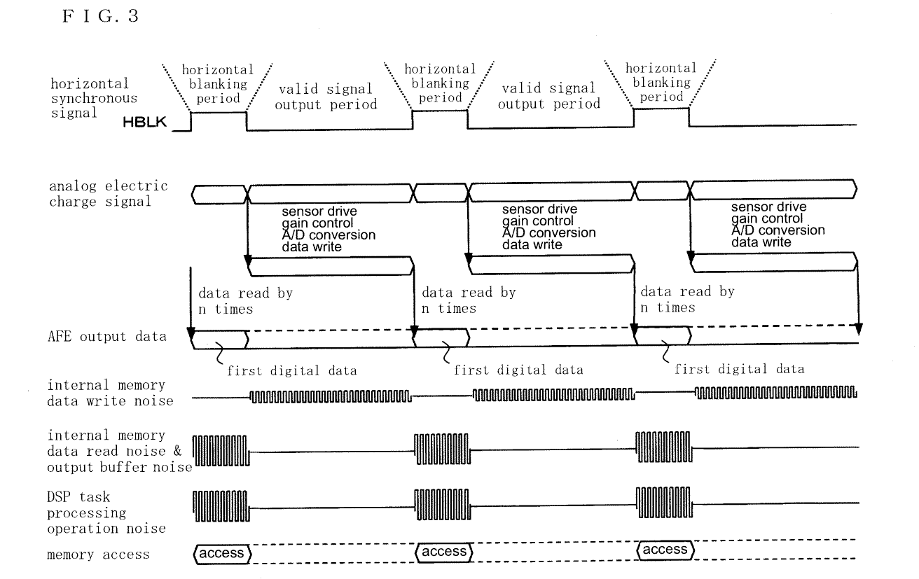

The operation of the analog front-end device 2 is described below referring to a timing chart illustrated in FIG. 3. When the timing generator section 22 generates the horizontal drive pulse and the vertical drive pulse, the image sensor 1 periodically outputs the analog electric charge signal at given intervals. The analog electric charge signal outputted from the image sensor 1, after the noise included therein is reduced by the CDS section 23, is gain-controlled by the GCA section 24 so as to have a given amplitude and then outputted to the AD converter section 25. The AD converter section 25 AD-converts the inputted analog electric charge signal and outputs the resulting data as the first digital data. The first memory control section 27 stores the first digital data outputted from the AD converter section 25 in the RAM 26. In FIG. 3, the RAM 26 is illustrated as a line buffer. Then, the first memory control section 27 reads the first digital data for a line stored in the RAM 26 at a high processing speed in synchronization with the read clock signal (multiplied clock) outputted from the clock multiplier section 28. The digital data output section 29 outputs the first digital data read by the first memory control section 27 to the digital signal processing device B in synchronization with the read clock single (multiplied clock) in the horizontal blanking period. As a result, the period when the operation noise caused by the data output of the analog front-end device 2 is confined solely to the horizontal blanking period.

Next, the operation of the digital signal processing device B is described referring to the timing chart of FIG. 3. When the digital data output section 29 outputs the first digital data in the horizontal blanking period, the pre-processing section 31 of the digital signal processing device B which received the outputted data performs gain and offset processes to the first digital data for a line to generate the second digital data in the horizontal blanking period, and writes the generated second digital data in the sharable memory 32 based on the control by the second memory control section 33. The second digital data written in the sharable memory 32 is transmitted to the image signal processing section 34, resizing section 35, compression/decompression section 36, region detection section 37, display processing section 38, and external I/F processing section 39 based on the control by the second memory control section 33, so that the respective sections process their tasks to the transmitted second digital data. The processing of tasks in the digital signal processing device B under the control by the second memory control section 33 are controlled by the execution program read from the flash memory 40 by the CPU 41.

The processing of tasks can be confined solely to the horizontal blanking period when the first digital data is fetched by:
1. using the CPU 41 to control the processing of tasks;
2. using the horizontal blanking signal inputted from the analog front-end device 2 or generated in the digital signal processing device B as an operation enable signal; or
3. combining the two methods 1 and 2.

According to the present exemplary embodiment wherein the sharable memory 32 is accessed by the digital signal processing device B and the flash memory 40 is accessed by the CPU 41 in the horizontal blanking period alone, the operation noise caused by the digital signal processing device B is generated exclusively in the horizontal blanking period.

As described so far, the digital camera according to the present exemplary embodiment is technically characterized in that the data is not outputted in the valid signal output period but is outputted the data in the horizontal blanking period alone, and the digital image processes that follow are performed in the horizontal blanking period alone. Therefore, the S/N performance of signals handled by the image sensor 1, CDS section 23, GCA section 24, and AD converter section 25 is prevented from deteriorating when the operation noise is generated by the data output and the image process.

In the case where the analog front-end device 2 is configured to convert the first digital data outputted to the digital signal processing device B in the form of parallel data, the electric level of the data output by the digital data output section 29 is preferably fixed during the valid signal output period. This eradicates any power supply and GND noise components caused by the output buffer of the digital signal processing device B to thereby reduce the noise affecting the pulses for driving the image sensor 1.

The digital data output section 29 may be provided with a differential amplifier to output the first digital data outputted to the digital signal processing device B as LVDS serial data. The LVDS (low voltage differential signaling) is one of conventional I/O specifications for converting parallel data into low-voltage differential serial data for data transmission. In the case where the first digital data is outputted as the LVDS serial data, a constant current source of the differential amplifier is turned off in the valid signal output period, and the output level of the first digital data is set to fixed logic. This eradicates high frequency power supply and GND noise components due to the LVDS operation, and also largely reduce power consumption of the digital data output section 29.

The digital data output section 29 preferably sets a transfer clock rate so that the output of the first digital data is completed within the horizontal blanking period. More specifically, when the digital data output section 29 outputs the first digital data as parallel data, the transfer clock rate is set as described below. First, a ratio of lengths of the horizontal blanking period and the valid signal output period (length of valid signal output period/length of horizontal blanking period) is calculated, and decimal places of the calculated ratio of lengths are carried so that an integer is obtained and used as a multiplying factor. When the clock is multiplied by the calculated multiplying factor, a transfer clock signal (transfer clock rate) is generated.

When the digital data output section 29 outputs the first digital data as the LVDS serial data, the transfer clock rate is set as described below. First, a ratio of lengths of the horizontal blanking period and the valid signal output period (length of valid signal output period/length of horizontal blanking period) is calculated, and decimal places of the calculated ratio of lengths are carried so that a first integer is obtained. Then, a third integer is calculated by multiplying the calculated first integer by a second integer indicating a data bus width after the AD conversion and used as a multiplying factor. When the clock is multiplied by the calculated multiplying factor, a transfer clock signal (transfer clock rate) is generated.

An imaging apparatus (digital camera) loaded with the imaging processing system according to the present exemplary embodiment as well as other structural elements such as lens and monitor can output a high-quality sensor data.

The analog front-end device 2 may have more than one output channel. The number of channels can be decided depending on the specification of the image sensor 1.

### Exemplary Embodiment 2

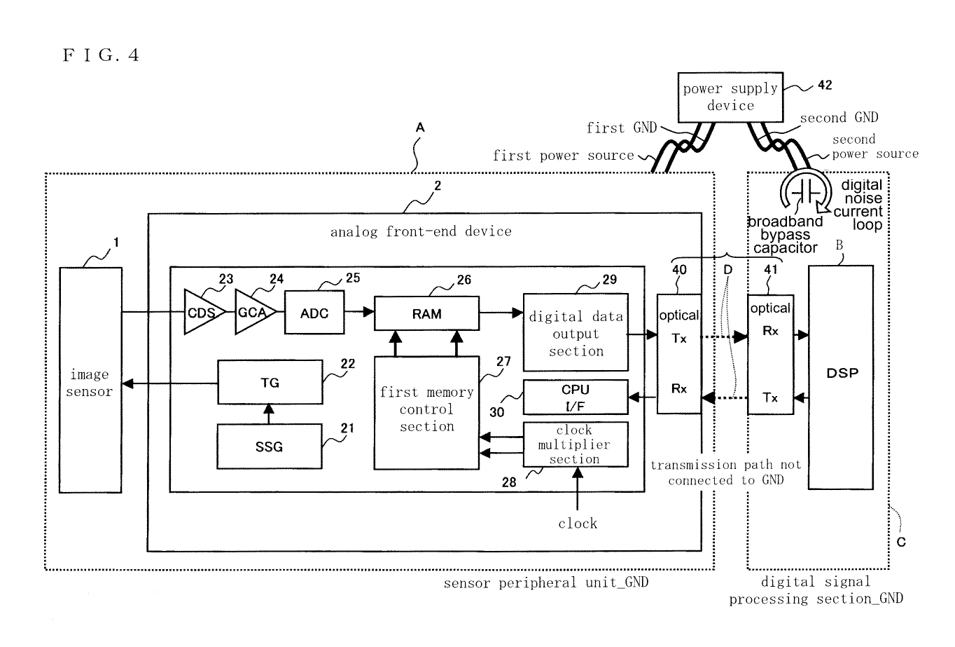

In the exemplary embodiment 1, the present invention is applied to the digital camera equipped with the LVDS high-speed metal transmission system. In an exemplary embodiment 2 of the present invention described referring to FIG. 4, the present invention is applied to a digital camera equipped with a high-speed optical transmission system. In the digital camera according to the exemplary embodiment 2, the analog front-end device 2 converts the parallel data into serial data in the form of a low voltage differential signal and optically transmits the low voltage differential signal as data output, and the digital signal processing device B receives the optically transmitted data.

The imaging system according to the present exemplary embodiment is basically configured similarly to that of the exemplary embodiment 1 described earlier referring to FIGS. 1-3 (particularly, FIG. 2). Therefore, the same or similar structural components of FIG. 4 as those of FIGS. 1-3 are illustrated with the same reference symbols and will not be described again. The present exemplary embodiment is different in that the analog front-end device 2 has an optical transceiver 40, and a digital signal processing device C includes an optical receiver 41 and a digital signal processor body. Since the digital signal processor body is similar to the digital signal processing device B according to the exemplary embodiment 1, the digital signal processor body is called a digital signal processor body B in the description given below.

The optical transceiver 40 and the optical receiver 41 optically transmit data through optical fiber D. The optical transceiver 40, optical receiver 41, and optical fiber D constitute an optical device 43. The present exemplary embodiment further includes a power supply device 42 configured to control power supply to the sensor peripheral unit A (including the analog front-end device 2) and the digital signal processing device C.

In the imaging system according to the present exemplary embodiment thus technically characterized, the analog front-end device 2 handles the first digital data which is parallel data as serial data and converts the serial data into the low voltage differential signal, and the optical transceiver 40 optically transmits the converted low voltage differential signal to the digital signal processing device C through the optical fiber C as data output. In the digital signal processing device C, the optical receiver 41 receives the optically transmitted data through the optical fiber C.

During the optical transmission, the analog front-end device 2 renders the optical transceiver 40 and the data output section 29 standby during the valid signal output period (any period other than the horizontal blanking period) to set an output optical level to one of a dark level and a bright level. During the horizontal blanking period, the analog front-end device 2 renders the optical transceiver 40 and the data output section 29 operational, and changes the output optical level fixed in the valid signal output period to be variable. The digital signal processor body B renders the optical receiver 4 (data input section) standby during the valid signal output period to set an output electric level in the digital signal processor body B to fixed logic. The digital signal processor body B renders the optical receiver 4 operational to set the output electric level fixed in the valid signal output period to be variable during the horizontal blanking period. According to the present exemplary embodiment thus configured, the high-speed optical transmission system to which the present invention is applied can largely reduce power consumption.

When the optical transmission is performed between the sensor peripheral unit A and the digital signal processing device C through the optical fiber C, the power supply device 42 can supply power independently to the sensor peripheral unit A and the digital signal processing device C without direct connection between a reference GND of the sensor peripheral unit A and a reference GND of the digital signal processing device C. More specifically, the power supply device 42 supplies a first power to the sensor peripheral unit A, and supplies a second power to the digital signal processing device C. The first reference GND connected to the sensor peripheral unit A and the second reference GND of the digital signal processing device are not directly connected to each other. The optical transmission path (optical fiber C) is structurally not connected to the GND. As a result, a digital noise current loop generated in the digital signal processor body B is prevented from affecting the sensor peripheral unit A. Therefore, the system operation noise generated by the operation or data output of the digital signal processor body B, if any, does not deteriorate the S/N performance of signals handled by the image sensor 1 and the AD converter section 25 of the sensor peripheral unit A. When a broadband bypass capacitor is provided between the digital signal processor body B and the power supply device 42, for example, any impact of the digital noise current loop can be more effectively eliminated.

### INDUSTRIAL APPLICABILITY

Describing the advantages of the imaging processing system according to the present invention, the digital data generated through AD conversion in the analog front-end device is outputted from the analog front-end device 2 to the digital signal processing device and the digital signal processes are performed at the same time in the horizontal blanking period when the output of the image sensor is invalid. The digital data output and the digital signal processes are not concurrent with the operations of the other circuits such as AD conversion. Therefore, the operation noise generated by the data output and the digital signal processes, if any, does not deteriorate the S/N performance of signals handled by the analog front-end device 2 including the image sensor and the AD converter section. Further, the video signal (analog electric charge signal) outputted from the solid image sensor of the digital camera is converted into digital data adapted to the analog electric charge signal and outputted for image processes.

What is claimed is:

1. An imaging processing system, comprising:
an analog front-end device configured to convert an analog electric charge signal outputted from a solid image sensor into a first digital data; and
a digital signal processing device configured to perform image processes to the first digital data, wherein
the analog front-end device outputs the first digital data in a blanking period of the solid image sensor, and
the digital signal processing device enables an internal operation of the digital signal processing device during the blanking period but renders the internal operation standby during any period but the blanking period.

2. The imaging processing system as claimed in claim 1, wherein the analog front-end device comprises:
a correlated double sampling section configured to convert the analog electric charge signal into a continuous analog signal by removing a noise therefrom;
an amplifier section configured to control a gain of an output signal of the correlated double sampling section and further control a direct current component of the output signal based on feedback control;
an n-bit AD converter section configured to generate the first digital data by analog-digital converting an output signal of the amplifier section;
a memory used as a temporary storage of the first digital data outputted from the AD converter section;
a first memory control section configured to write the first digital data in the memory based on a write clock signal and reads the first digital data from the memory based on a read clock signal having a clock frequency higher than a clock frequency of the write clock signal;
a digital data output section configured to output the first digital data read from the memory to the digital signal processing device;
a synchronous signal generator section configured to generate a synchronous signal based on which a cycle of reading the analog electric charge signal is set in the solid image sensor;
a timing generator section configured to generate a pulse for driving the solid image sensor based on the synchronous signal; and
a clock multiplier section configured to generate the write clock signal based on a clock inputted from outside and generate the read clock signal by multiplying the clock by n times, and then supply the generated write clock signal and read clock signal to the first memory control section.

3. The imaging processing system as claimed in claim 2, wherein
the memory has a memory capacity large enough to buffer the first digital data for at least a line of the solid image sensor, and
the first memory control section writes the first digital data in the memory in an output period of the analog electric charge signals for at least a line and reads the first digital data from the memory in a horizontal blanking period which immediately follows the output period.

4. The imaging processing system as claimed in claim 2, wherein the digital signal processing device comprises:
a pre-processing section configured to perform DC and gain adjustments to the first digital data received from the analog front-end device to generate a second digital data;
a sharable memory used as a storage of the second digital data outputted from the pre-processing section;
a second memory control section configured to write the second digital data in the sharable memory and read the second digital data from the sharable memory;
a group of signal processing sections configured to perform various image processes to the second digital data read from the sharable memory;
an external I/F processing section serving as an interface with outside;
a CPU configured to control the operations of the group of signal processing sections; and
a clock control section configured to multiply or divide the clock inputted from outside by n times and supply the multiplied or divided clock to the group of processing sections.

5. The imaging processing system as claimed in claim 4, wherein the group of signal processing sections includes:
a image signal processing section configured to perform a brightness signal process and a color signal process to the second digital data read from the sharable memory;
a resizing section configured to perform a resizing process to the signal-processed second digital data outputted from the image signal processing section;
a compression/decompression section configured to compress or decompress the resized second digital data outputted from the resizing section;
a region detection section configured to perform a region detection process to the resized second digital data outputted from the resizing section; and
a display processing section configured to output the resized second digital data outputted from the resizing section outside as a display data.

6. The imaging processing system as claimed in claim 4, wherein
the digital signal processing device enables the operation of the pre-processing section during a horizontal blanking period but renders the operation standby during any period but the horizontal blanking period, and
the digital signal processing device further enables the operations of the group of signal processing sections during the horizontal blanking period and a vertical blanking period.

7. The imaging processing system as claimed in claim 4, wherein
the digital signal processing device enables the operation of the CPU alone but renders the group of processing sections standby when a minimum range of operation setting including standby is arranged in the output period of the analog electric charge signals of the solid image sensor, and
the digital signal processing device further renders the CPU standby in the output period of the analog electric charge signals of the solid image sensor.

8. The imaging processing system as claimed in claim 1, wherein
the analog front-end device performs parallel output of the first digital data but fixes an output electric level of the first digital data during any period but a horizontal blanking period of the solid image sensor.

9. The imaging processing system as claimed in claim 2, wherein
the analog front-end device generates the first digital data as a parallel data and converts the first digital data into a serial data through low-voltage differential conversion, and then transmits the serial data to the digital signal processing device, and
the analog front-end device further renders the digital data output section standby to set an output level of the analog front-end device to fixed logic during any period but a horizontal blanking period.

10. The imaging processing system as claimed in claim 9, wherein the digital signal processing device renders the pre-processing section standby to set an output level of the digital signal processing device to fixed logic during any period but the horizontal blanking period.

11. The imaging processing system as claimed in claim 2, wherein
the analog front-end device generates the first digital data as a parallel data and converts the first digital data into a serial data through low-voltage differential conversion, and then optically transmits the serial data by using an optical device to the digital signal processing device through optical fiber by way of an optical transceiver, and
the analog front-end device further renders the optical transceiver and the digital data output section standby to set an output optical level of the analog front-end device to one of a bright level and a dark level during any period but a horizontal blanking period.

12. The imaging processing system as claimed in claim 11, wherein
the digital signal processing device receives the first digital data transmitted through the optical fiber using the optical receiver, and renders the optical transceiver standby to set an output electric level of the first digital data to fixed logic during any period but the horizontal blanking period.

13. The imaging processing system as claimed in claim 11, further including a power supply device configured to supply power to the analog front-end device and the digital signal processing device, wherein
the power supply device supplies power independently to the analog front-end device and the digital signal processing device without direct connection between a reference GND of the analog front-end device and a reference GND of the digital signal processing device.

14. The imaging processing system as claimed in claim 9, wherein
the first memory control section reads the first digital data from the memory based on the read clock signal obtained by multiplying the write clock signal by a multiplying factor equal to or larger than a third integer, the third integer being obtained by multiplying a first integer which is a ratio of lengths (decimal places are carried) of the horizontal blanking period and the valid signal output period (length of valid signal output period/length of horizontal blanking period) by a second integer indicating a data bus width after A/D conversion, and
the digital data output section transfers the first digital data in the horizontal blanking period based on a transfer clock signal having a transfer clock frequency equal to a read clock frequency of the read clock signal.

15. The imaging processing system as claimed in claim 2, wherein
the first digital data is a parallel data, and
a transfer rate of the digital data output section is set so that the output of the first digital data is completed during the horizontal blanking period.

16. The imaging processing system as claimed in claim 15, wherein
the digital data output section transfers the first digital data based on a first transfer clock signal having a first transfer clock frequency in the valid signal output period, and transfers the first digital data in the horizontal blanking period based on a second transfer clock signal having a second transfer clock frequency obtained by multiplying the first transfer clock frequency by a multiplying factor equal to or larger than an integer which is a ratio of lengths (decimal places are carried) of the horizontal blanking period and the valid signal output period (length of valid signal output period/length of horizontal blanking period).

17. A digital camera comprising the imaging processing system as claimed in claim 1 and the solid image sensor.
